(19) United States
(12) Patent Application Publication
(10) Pub. No.: US 2005/0223758 A1
(43) Pub. Date: Oct. 13, 2005

(54) Storage device for safety check media of locks

(76) Inventor: Chun-Te Yu, Fu-Hsing Hsiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/942,790

(22) Filed: Sep. 17, 2004

(30) Foreign Application Priority Data
Apr. 9, 2004 (TW) 93205549

(51) Int. Cl. E05B 65/52; E05B 37/00

(52) U.S. Cl. 70/63; 70/284

(57) ABSTRACT

A storage device for safety check media of locks, including a lock main body controlled by an external control member and a check cover connected with the main body. A storage space is defined between the main body and the check cover. At least a mark unit is previously disposed in the storage space for showing a correct unlocking number of a confidential numeral lock. The opening/closing of the check cover is controlled by a preset numeral lock. In addition, a key-driven lock is disposed between the check cover and the main body. The key-driven lock has a keyhole in which only a safety check general key can be inserted to unlock the key-driven lock for opening the check cover.

### BACKGROUND OF THE INVENTION

The present invention is related to a storage device for safety check media of locks. The storage device is applicable to the lock of a baggage case, enabling a safety checker to readily unlock various types of locks for checking the contents in the baggage case.

A conventional baggage case is equipped with a lock for preventing the contents in the baggage case from missing or being stolen. The lock can be directly disposed on the baggage case by a manufacturer or purchased and additionally mounted on the baggage case by a user.

The above locks include key-driven type and numeral type. Only when a correct is key is inserted into the lock or the numeral wheels of the lock are turned to a correct number, the lock can be unlocked.

When traveling abroad, the baggage case will be checked by customs workers to ensure safety. Nowadays, the check is executed more strictly to avoid terrors. For example, the travelers are required by U.S. customs to unlock the locks of the baggage cases themselves, whereby the customs workers can open the baggage cases to check the contents as necessary. In the case that the baggage cases are not previously unlocked, the customs workers are authorized by U.S. government to forcedly break off the lock of the baggage cases to open the same for checking the contents. The damaged lock will be a loss of the user and will lead to trouble and inconvenience to the user. In order to improve the above situation, the lock manufacturers will provide a general key for the customs to unlock all the locks of similar modes. However, when encountering the numeral type lock, it will be impossible for the customs workers to conveniently unlock the lock for safety check.

### SUMMARY OF THE INVENTION

It is therefore a primary object of the present invention to provide a storage device for safety check media of locks. The storage device is applicable to the lock of a baggage case, enabling a safety checker to conveniently unlock various types of locks for checking the contents in the baggage case.

According to the above object, the storage device for safety check media of locks of the present invention includes a lock main body controlled by an external control member and a check cover connected with the main body and openable/closable by the control member. A storage space is defined between the main body and the check cover. At least a mark unit is previously disposed in the storage space for showing a correct unlocking number of a confidential numeral lock. A key-driven lock is additionally disposed between the check cover and the main body. The key-driven lock has a keyhole. In safety check, a safety check general key can be inserted into the keyhole to open the check cover.

In the above storage device, at least one key for unlocking the key-driven lock of the baggage case is further previously placed in the storage space.

In the above storage device, the mark unit previously disposed in the storage space includes a row of marked numeral wheels showing a correct unlocking number of the confidential numeral lock.

In the above storage device, the check cover has an exposed keyhole and a lock linked with a rotary shaft. An inner end of the rotary shaft is formed with a projecting block. The storage space is formed with a dent corresponding to the cross-section of the shaft body of the rotary shaft and the projecting block.

In the above storage device, the control member is linked with an engaging unit for releasing or restricting the marked numeral wheels. In a locked state, the engaging unit serves to prevent the marked numeral wheels from being unexpectedly turned so as to avoid random code.

In the above storage device, the mark unit previously disposed in the storage space is a mark plate showing the correct unlocking number of the confidential numeral lock.

The present invention can be best understood through the following description and accompanying drawings wherein:

### BRIEF DESCRIPTION OF THE DRAWINGS

FIG. 1 is a perspective view of a preferred embodiment of the present invention;

FIG. 2 is a front partially sectional view of the present invention;

FIG. 3 is a perspective view according to FIG. 1, showing that the check cover is opened;

FIG. 4 is a sectional view according to FIG. 3;

FIG. 5 is a sectional taken along line A-A of FIG. 4;

FIG. 6 is a perspective view according to FIG. 1, showing that the hanging cord is opened;

FIG. 7 shows that the present invention is applied to a suitcase;

FIG. 8 is a perspective view of another embodiment of the present invention, in which the check cover is opened;

FIG. 9 is a perspective view of still another embodiment of the present invention, which has a turning type check cover; and

FIG. 9A is a perspective view according to FIG. 9, showing that the check cover is turned open.

### DETAILED DESCRIPTION OF THE PREFERRED EMBODIMENTS

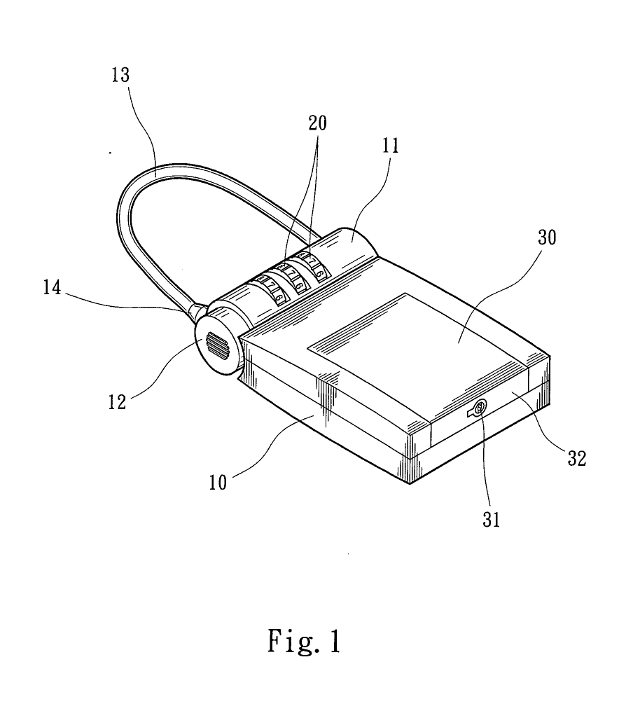

Please refer to FIG. 1. The present invention is applied to a numeral hanging lock main body 10 having a hanging cord 13. A row of numeral wheels 101 are arranged on top section 11 of the lock main body 10. A control button 12 is disposed on one side of the top section 11. One end of the hanging cord 13 is fixed on the top section 11, while the other end 14 of the hanging cord 13 can be released when unlocked. In normal state, the hanging cord 13 is looped.

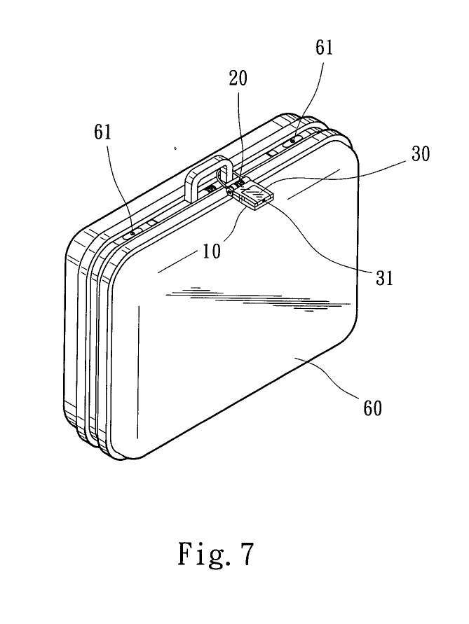

Referring to FIGS. 1 to 3, a check cover 30 is connected with the main body 10. The numeral wheels 101 can cooperate with the control button 12 to drive a restricting member 151 for controlling the opening/closing of the check cover 30. A storage space 90 is defined between the lock main body 10 and the check cover 30. At least a mark unit 2 is previously disposed in the storage space 90 for showing the unlocking number of another confidential numeral lock having a row of numeral wheels 20 ( referring to the numeral lock of the suitcase of FIG. 7 ). In addition, a key 40 can be selectively placed in the storage space 90.

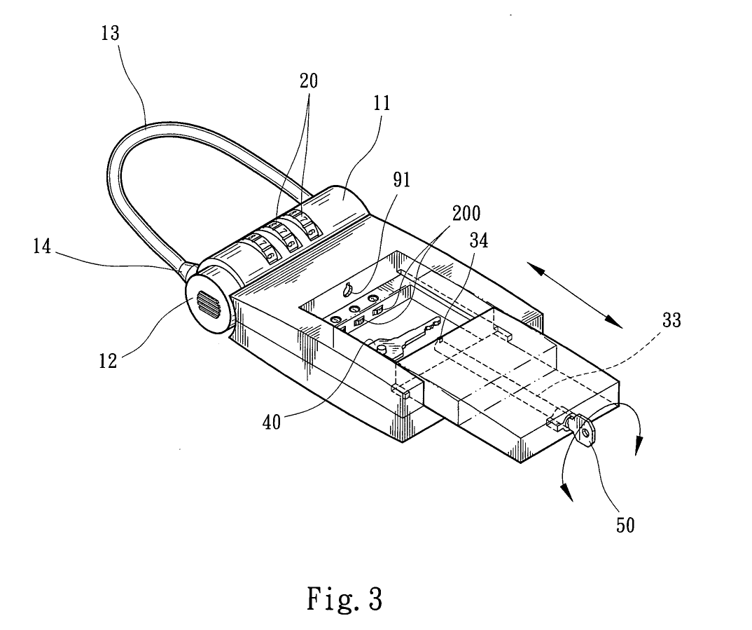

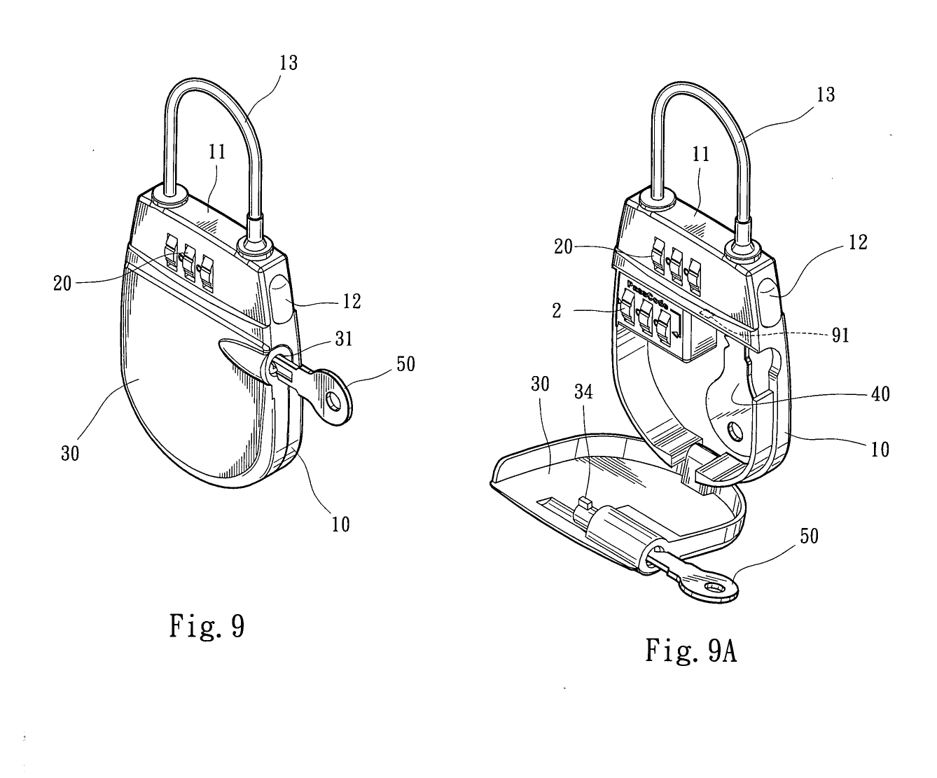

An outer end face of the check cover 30 can be previously formed with a keyhole 31 of a lock. In this embodiment, the keyhole 31 is formed on front end face 32 of the check cover 30. However, alternatively, the keyhole 31 can be formed on any other portion of the outer face for easy unlocking ( as shown in FIGS. 9 and 9A). A specific general key 50 provided by a lock manufacturer for the customs workers can be inserted into the keyhole 31 to unlock the lock as shown in FIG. 3.

Referring to FIG. 3, the mark unit 2 previously disposed in the storage space 90 can be a row of marked numeral wheels 200 showing a correct unlocking number of a confidential numeral lock.

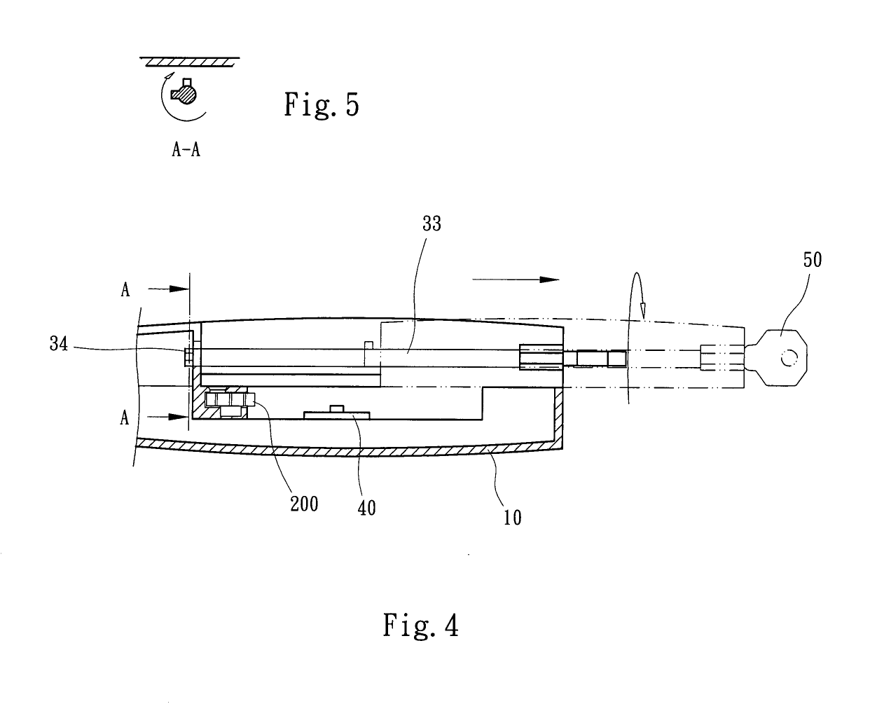

In a preferred embodiment as shown in FIGS. 3 to 5, the lock of the check cover 30 with the keyhole 31 is linked with a rotary shaft 33. An inner end of the rotary shaft 33 is formed with a projecting block 34. The storage space 90 is formed with a dent 91 corresponding to the cross-section of the shaft body of the rotary shaft 33 and the projecting block 34. In a normal locked position, the projecting block 34 of the rotary shaft 33 is vertical. After turned, the projecting block 34 becomes horizontal, whereby the check cover 30 can be drawn out into an open state as shown in FIGS. 3 and 4 to show the numeral wheels 20 of the confidential numeral lock. At the same time, in the case that the lock apparatus further includes a key-driven lock, the key 40 for the key-driven lock can be previously placed in the storage space 90.

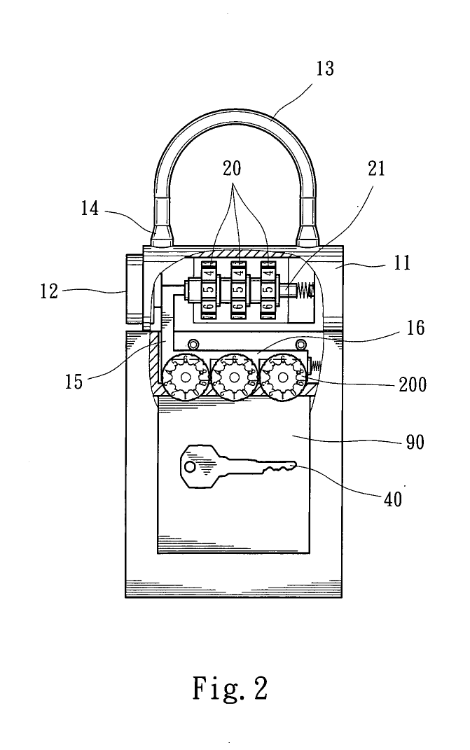

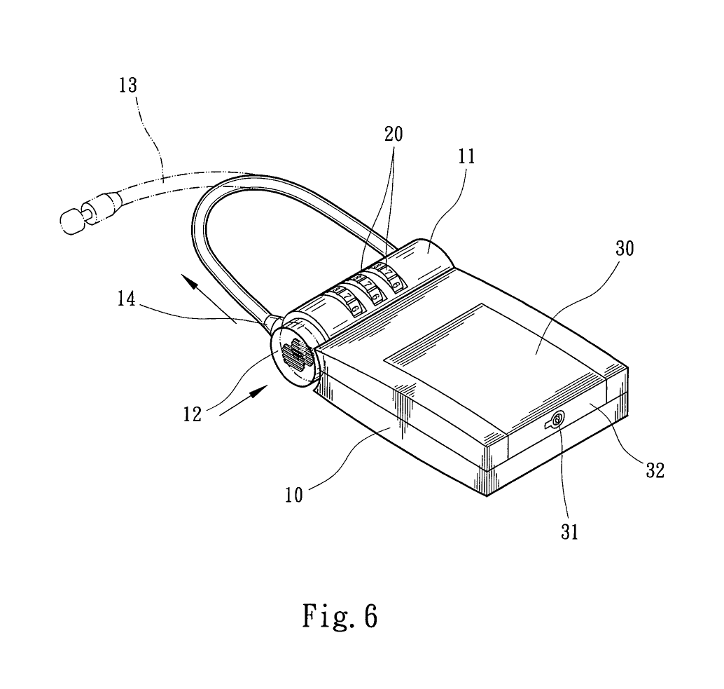

Referring to FIGS. 2 to 6, in this embodiment, when the numeral wheels 101 of the lock main body 10 are turned to the correct unlocking number, the control button 12 can be inward pressed to unlock the numeral lock. At this time, the hanging cord 13 can be opened as shown by phantom line of FIG. 6. Also, the control button 12 can be connected with a linking member 15 and a restricting member 151. In natural state, the restricting member 151 stops the projecting block 34 so that the check cover 30 cannot be opened. Reversely, when the restricting member 151 is pressed by the control button 12 and displaced, the restricting member 151 releases the projecting block 34, permitting the check cover 30 to be opened.

The present invention is applicable to the baggage case as shown in FIG. 7. The baggage case 60 has its own key-driven lock 61 and numeral lock composed of a row of numeral wheels 20, that is, the aforesaid confidential numeral lock. The two locks provide double protective effects. Under such circumstance, a safety checker can insert the general key 50 into the exposed keyhole 31 to open the check cover 30, whereby the internal mark unit 2 can show the unlocking number of the numeral lock. Also, the key 40 for the key-driven lock 61 can be taken out for unlocking the same so as to open the baggage case and check the contents.

Referring to FIG. 2, due to incautious touch, the numeral wheels 200 of the mark unit 2 may be unexpectedly turned into a random code (incorrect unlocking number). In order to avoid this, the linking member 15 connected with the control button 12 is also linked with an integral or a not integral transverse engaging unit 16. In an unlocked state, the internal marked numeral wheels 200 are released. Reversely, in a locked state, the marking numeral wheels 200 are restricted from being turned so as to avoid random code caused by incautious touch.

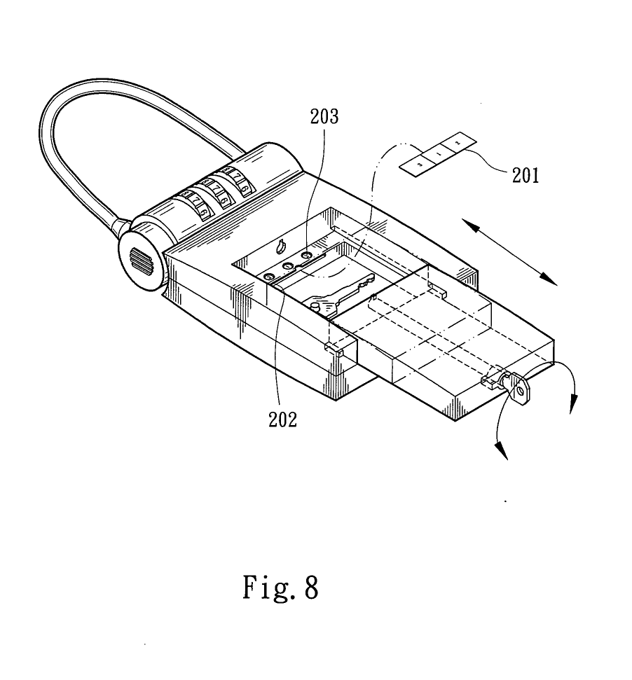

FIG. 8 shows another embodiment of the present invention, in which the correct unlocking number of the numeral wheels 20 can be alternatively shown by a mark plate 201. In this embodiment, the mark plate 201 is inserted in an insertion slot 202 having numeral windows 203.

According to the above arrangement, the present invention is applicable to various baggage cases with different types of locks. The present invention enables a safety checker to more quickly and conveniently perform security checking operation.

The above embodiments are only used to illustrate the present invention, not intended to limit the scope thereof. Many modifications of the above embodiments can be made without departing from the spirit of the present invention. For example, FIGS. 9 and 9A show another aspect of the present invention, in which the positions of the check cover 30, mark unit 2, control button 12, hanging cord 13 and linking member 15 are adjusted. The manner in which the check cover 30 is opened is also changed to form a turning type check cover 30.

1. A storage device for safety check media of locks, comprising a main body and a check cover connected with the main body, a storage space being defined between the main body and the check cover, at least a mark unit being previously disposed in the storage space for showing a correct unlocking number of a confidential numeral lock, a numeral lock and a key-driven lock being disposed between the check cover and the main body for respectively opening/closing the check cover, the numeral lock via a control member controlling opening/closing of the check cover, the key-driven lock having a keyhole in which only a safety check general key can be inserted to open the check cover.

2. The storage device for safety check media of locks as claimed in claim 1, wherein at least one key for unlocking the key-driven lock of the lock main body is further previously placed in the storage space.

3. The storage device for safety check media of locks as claimed in claim 1, wherein the mark unit previously disposed in the storage space includes a row of marked numeral wheels showing a correct unlocking number of the confidential numeral lock.

4. The storage device for safety check media of locks as claimed in claim 2, wherein the mark unit previously disposed in the storage space includes a row of marked numeral wheels showing a correct unlocking number of the confidential numeral lock.

5. The storage device for safety check media of locks as claimed in claim 1, wherein the check cover has an exposed keyhole and a lock linked with a rotary shaft, an inner end of the rotary shaft being formed with a projecting block, the storage space being formed with a dent corresponding to the cross-section of the projecting block, a restricting member being disposed in the dent, the restricting member being drivable by the control member, whereby when the numeral lock is locked, the restricting member restricts the projecting block from detaching from the dent so as to prevent the check cover from being opened.

6. The storage device for safety check media of locks as claimed in claim 2, wherein the check cover has an exposed keyhole and a lock linked with a rotary shaft, an inner end of the rotary shaft being formed with a projecting block, the storage space being formed with a dent corresponding to the cross-section of the projecting block, a restricting member being disposed in the dent, the restricting member being drivable by the control member, whereby when the numeral lock is locked, the restricting member restricts the projecting block from detaching from the dent so as to prevent the check cover from being opened.

7. The storage device for safety check media of locks as claimed in claim 3, wherein the control member is linked with an engaging unit for releasing or restricting the marked numeral wheels.

8. The storage device for safety check media of locks as claimed in claim 4, wherein the control member is linked with an engaging unit for releasing or restricting the marked numeral wheels.

9. The storage device for safety check media of locks as claimed in claim 1, wherein the mark unit previously disposed in the storage space is a mark plate showing the correct unlocking number of the confidential numeral lock.

10. The storage device for safety check media of locks as claimed in claim 9, wherein the mark plate is inserted in an insertion slot having numeral windows.

11. The storage device for safety check media of locks as claimed in claim 1, wherein the check cover is a turning type check cover.

12. The storage device for safety check media of locks as claimed in claim 2, wherein the check cover is a turning type check cover.

13. The storage device for safety check media of locks as claimed in claim 9, wherein the check cover is a turning type check cover.

14. The storage device for safety check media of locks as claimed in claim 10, wherein the check cover is a turning type check cover.

15. The storage device for safety check media of locks as claimed in claim 3, wherein the check cover is a turning type check cover.

16. The storage device for safety check media of locks as claimed in claim 4, wherein the check cover is a turning type check cover.

17. The storage device for safety check media of locks as claimed in claim 5, wherein the check cover is a turning type check cover.

18. The storage device for safety check media of locks as claimed in claim 6, wherein the check cover is a turning type check cover.

19. The storage device for safety check media of locks as claimed in claim 7, wherein the check cover is a turning type check cover.

20. The storage device for safety check media of locks as claimed in claim 8, wherein the check cover is a turning type check cover.

21. The storage device for safety check media of locks as claimed in claim 1, wherein the check cover is a slide type check cover.

22. The storage device for safety check media of locks as claimed in claim 2, wherein the check cover is a slide type check cover.

23. The storage device for safety check media of locks as claimed in claim 9, wherein the check cover is a slide type check cover.

24. The storage device for safety check media of locks as claimed in claim 14, wherein the check cover is a slide type check cover.

25. The storage device for safety check media of locks as claimed in claim 3, wherein the check cover is a slide type check cover.

26. The storage device for safety check media of locks as claimed in claim 4, wherein the check cover is a slide type check cover.

27. The storage device for safety check media of locks as claimed in claim 5, wherein the check cover is a slide type check cover.

28. The storage device for safety check media of locks as claimed in claim 6, wherein the check cover is a slide type check cover.

29. The storage device for safety check media of locks as claimed in claim 7, wherein the check cover is a slide type check cover.

30. The storage device for safety check media of locks as claimed in claim 8, wherein the check cover is a slide type check cover.
